(19) United States
(12) Patent Application Publication
(10) Pub. No.: US 2006/0285044 A1
(43) Pub. Date: Dec. 21, 2006

(54) Liquid crystal display device and manufacturing method for the same

(76) Inventors: Kang-Hung Liu, Tao Yuan Hsien (TW); Chi-Chang Liao, Tai Nan City (TW); Shie-Chang Jeng, Ping Tung Hsien (TW); Yi-An Sha, Taipei City (TW)

Correspondence Address: RABIN & BERDO, P.C.;Suite 500, 1101 14 Street, N.W., Washington, DC, 20005, US

(21) Appl. No.: 11/280,255

(22) Filed: Nov. 17, 2005

(30) Foreign Application Priority Data
Jun. 21, 2005 (TW) 94120607

(51) Int. Cl. G02F 1/1337

(52) U.S. Cl. 349/123

(57) ABSTRACT

A liquid crystal display (LCD) device and a manufacture method for the same are proposed in the present invention. The LCD device of the present invention has a top substrate, a bottom substrate, an upper alignment film, a lower alignment film and a liquid crystal layer. The LCD device and the method of the present invention use different alignment materials to form the alignment films on the top and bottom substrates. Due to different properties of the alignment films, multiple liquid crystal domains with different alignment orientations are provided.

### BACKGROUND OF THE INVENTION

1. Field of the Invention

The present invention is related to a liquid crystal display device and a manufacturing method for the same, and more particularly, to a liquid crystal display device and a manufacturing method thereof that use different alignment materials to provide alignment films on the top substrate and the bottom substrate. Due to the different influences of different alignment materials for liquid crystals, liquid crystal cells have multiple alignment domains formed therein.

2. Description of Related Art

Multi-domain techniques used to control alignment directions of liquid crystals have been extensively applied in liquid crystal display (LCD) devices. For example, the multi-domain techniques can be applied to manufacture transflective LCD devices, widen the viewing angle of common LCD devices, and increase the reflective spectrum or viewing angle of cholesteric liquid crystal devices. Generally, photo alignment, protrusions and fringe electric field are often used to form multiple alignment domains of liquid crystals.

First, two examples of using the photo alignment technique to manufacture transflective LCD devices are given as follows. Reference is made to FIGS. 1-2, which are transflective LCD devices disclosed in U.S. Pat. No. 6,862,065 and U.S. Publication No. 2004/0032555, respectively. FIG. 1 shows a conventional LCD device 10, which has a top substrate and a bottom substrate. The bottom substrate has a reflective region and a transmissive region. By using optical masks and ultraviolet light, the reflective region and the transmissive region are formed with different pre-tilt angles. The best transmissive or reflective effect is provided. Similarly, the reflective region and the transmissive region of the conventional LCD device 20 are also formed by using optical masks and ultraviolet light. The difference between the conventional LCD devices 10 and 20 is the structures of the reflective region and the transmissive region.

Next, an example for using the protrusions to widen the viewing angle of LCD devices is given as follows. Reference is made to FIG. 3. As shown in FIG. 3, the conventional LCD device 30 uses protrusions to control the alignment directions of liquid crystals to form multiple alignment domains. For instance, the top and bottom substrates respectively have bumps formed thereon. The bumps can make liquid crystals incline in predetermined directions. The dielectric constant of the material of the bumps should be smaller than that of the liquid crystals.

Lastly, an example of using protrusions together with fringe electric fields provided via pixel electrodes to widen the viewing angle of LCD devices is given as follows. Reference is made to FIG. 4. As shown in FIG. 4, the conventional LCD device 40 has a Y-Y projective block formed on the top substrate. Via the disposition of the Y-Y projective block, an approximate two-domain structure is formed. The alignment direction of liquid crystals can be controlled via voltage adjustment. To further simplify the manufacturing procedure, the alignment direction of liquid crystals can be controlled by using fringe electric fields.

However, the conventional LCD devices mentioned above still have some drawbacks in cost and manufacturing procedures. In the case of using the photo alignment technique, additional optical masks and ultraviolet light are needed in the manufacturing procedure. Moreover, the photo alignment technique is not easy to use in the manufacture of large-sized LCD devices. In addition, in the case of using the protrusion technique, additional manufacturing steps are required and the protrusions must be formed precisely. Lastly, in the case of using electric fields to control the alignment directions of liquid crystals, the patterned electrodes is required, the improvement on widening the viewing angle is limited, and a large driving voltage is needed.

### SUMMARY OF THE INVENTION

The objective of the present invention is to provide a liquid crystal display (LCD) device and a manufacturing method for the same. The present invention uses different alignment materials to form the alignment films on the substrates. Due to different properties of the alignment films, multiple liquid crystal domains with different alignment arrangements are provided. In this way, the cost is reduced and the manufacturing procedure is simplified.

For achieving the objective above, the present invention provides a LCD device, including a top substrate, a bottom substrate, an upper alignment film, a lower alignment film, and a liquid crystal layer between the top and bottom substrate. The LCD device can further include a top electrode layer, a bottom electrode layer and a color filter.

It should be noted that the alignment films are formed by providing different alignment materials on the substrates. Due to different properties of the alignment films, multiple liquid crystal domains with different alignment orientation are provided. When liquid crystals contact the different alignment films, they are aligned in different orientations. The upper or lower alignment film is made of at least two different alignment materials. The alignment materials that are capable of making liquid crystals aligned in different orientation or pre-tilt angle can be obtained by mixing the vertical and horizontal alignment materials with a different ratio. After a phase separation process is performed, the mixture of the alignment materials can align liquid crystals with a pre-tilt angle that ranges between 0° to 90°, depending on the mixing ratio.

Several methods could be implemented to form different alignment materials on the corresponding regions of substrates, and it becomes a patterned alignment layer. For example, the patterned alignment layers are formed by filling different alignment materials to a patterned substrate defined by multiple separating walls or by surface treatment on the substrates. Moreover, the different alignment materials can also be filled directly on the corresponding regions of the substrates.

The alignment orientations of multiple liquid crystal domains make the LCD device of the present invention have a property of wide viewing angle. Furthermore, when this structure is applied to the cholesteric liquid crystal display, it will have the properties of wide viewing angle and broad reflective spectrum. In addition, this multi domain structure could be applied to form a transflective LCD. In such display device, the bottom substrate further includes multiple reflective regions with reflectors and transmissive regions not covered by the reflectors, where the two types of regions are filled with different alignment materials. The reflective regions are filled with the vertical alignment material and the transmissive regions are filled with horizontal alignment material. The upper alignment film of the top substrate is filled with the horizontal alignment material.

For achieving the objective above, the present invention provides a method for manufacturing a LCD device, including providing a top substrate and a bottom substrate; providing different alignment materials on the corresponding regions of the substrates; and filling liquid crystals between the top and bottom substrate.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a cross-sectional view of the first related art of transflective LCD device;

FIG. 2 is a cross-sectional view of the second related art of transflective LCD device;

FIG. 3 is a cross-sectional view of the third related art of wide viewing angle LCD device;

FIG. 4 is a cross-sectional view of the forth related art of wide viewing angle LCD device;

FIG. 5A is a cross-sectional view of a LCD device in accordance with the present invention;

FIG. 5B is a cross-sectional view of another LCD device in accordance with the present invention;

FIG. 6A shows the first embodiment of a method for providing an alignment film on the bottom substrate in accordance with the present invention;

FIG. 6B shows the second embodiment of a method for providing an alignment film on the bottom substrate in accordance with the present invention;

FIG. 6C shows the third embodiment of a method for providing an alignment film on the bottom substrate in accordance with the present invention;

FIG. 7A shows the first embodiment of a method for providing an alignment film on the top substrate in accordance with the present invention;

FIG. 7B shows the second embodiment of a method for providing an alignment film on the top substrate in accordance with the present invention; and

FIG. 8 is a flowchart showing a manufacturing procedure of a LCD device in accordance with the present invention.

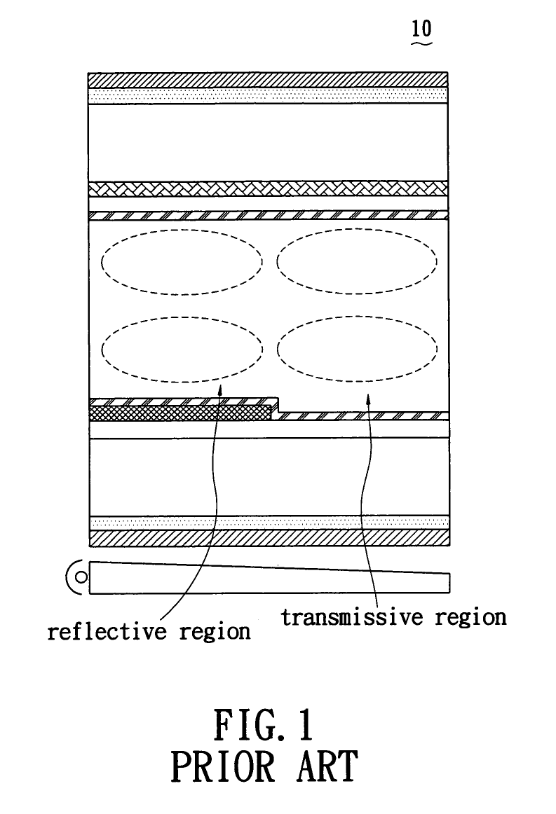

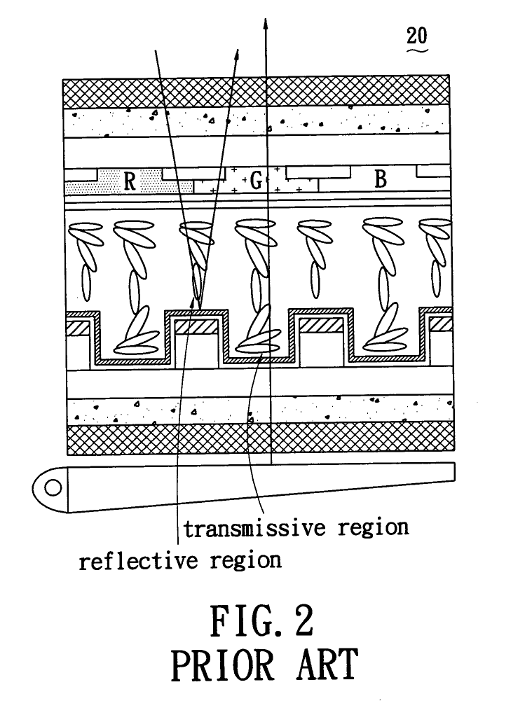

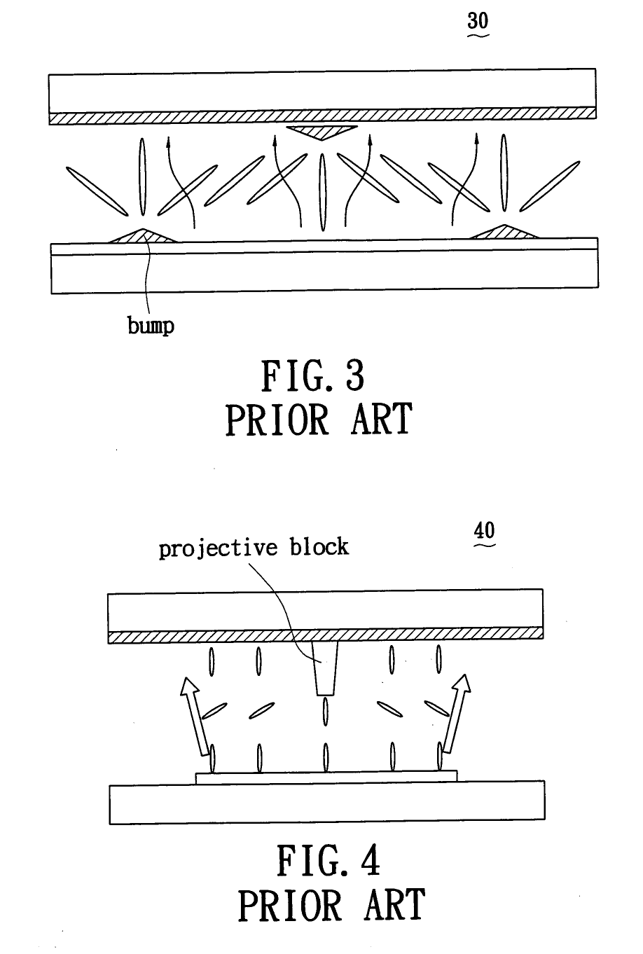

### DETAILED DESCRIPTION OF PREFERRED EMBODIMENTS

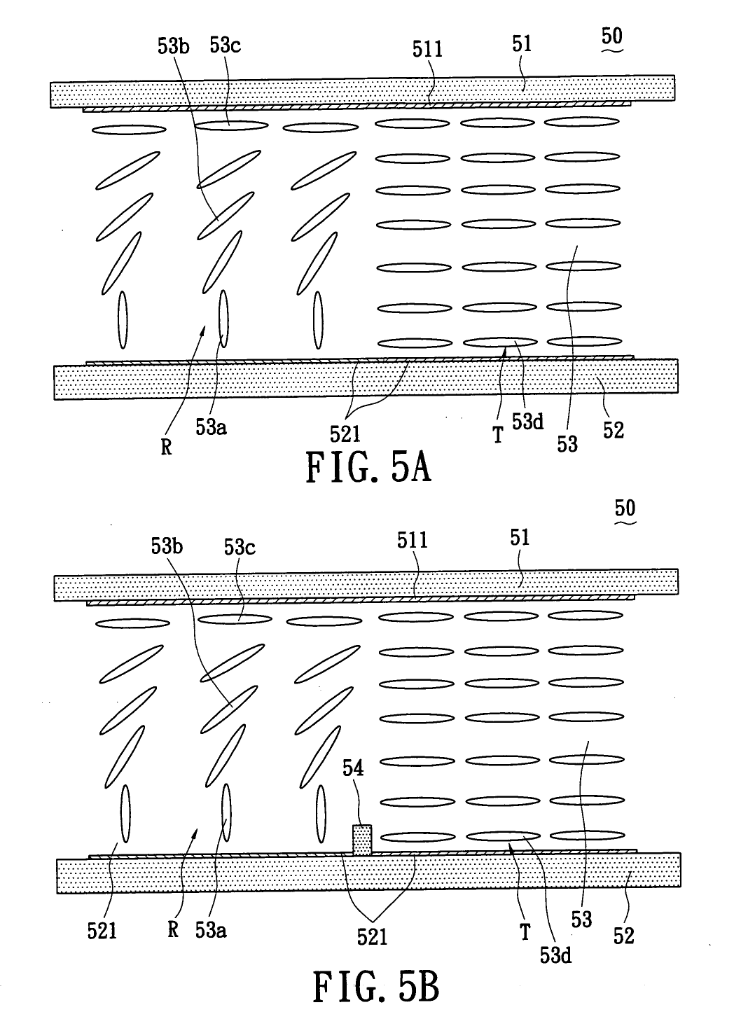

Reference is made to FIGS. 5A and 5B. When the present invention is applied to a transflective display device, the transflective display device 50 includes a top substrate 51, a bottom substrate 52, an upper alignment film 511, a lower alignment film 521, and a liquid crystal layer 53. The upper alignment film 511 is disposed below the top substrate 51 while the lower alignment film 521 is disposed above the bottom substrate 52. The liquid crystal layer 53 is formed between the top substrate 51 and the bottom substrate 52. The gap between the top substrate 51 and the bottom substrate 52 is therefore filled with a liquid crystal material. The bottom substrate 52 has multiple reflectors disposed thereon to form multiple reflective regions R, while other regions not covered by the reflectors form multiple transmissive regions T.

For such transflective LCD, two different alignment materials are provided to form the upper alignment film 511 or the lower alignment film 521 (in this embodiment, only the lower alignment film 521 is formed by using two different alignment materials). Thus, the corresponding two different domains 53a and 53d are formed thereby. When the liquid crystals contact these two different alignment materials, different alignment orientations are formed. In FIGS. 5A and 5B, the upper alignment film 511 could be formed by using the same alignment material used to form the domain 53d. In this way, the liquid crystals are aligned in the vertical direction in the domain 53a and are aligned in the horizontal direction in the other domains. Therefore, the best optical design for the transflective display is obtained.

In order to provide different alignment materials on the top substrate 51 or the bottom substrate 52, multiple separating walls 54 are disposed on the substrates (FIG. 5 only shows the bottom substrate) to separate the regions corresponding to different alignment materials. Moreover, the top substrate 51 or the bottom substrate 52 can also be processed to form a patterned structure corresponding to the different alignment materials. In practice, the different alignment materials can also be directly provided on the corresponding regions of the top substrate 51 or the bottom substrate 52. Several methods could be implemented to form different alignment materials on the corresponding regions of substrates, and it becomes a patterned alignment layer. The patterned alignment layers could be fabricated by filling different alignment materials to a patterned substrate defined by multiple separating walls or by surface treatment on the substrates. Moreover, the different alignment materials can also be filled directly on the corresponding regions of the substrates.

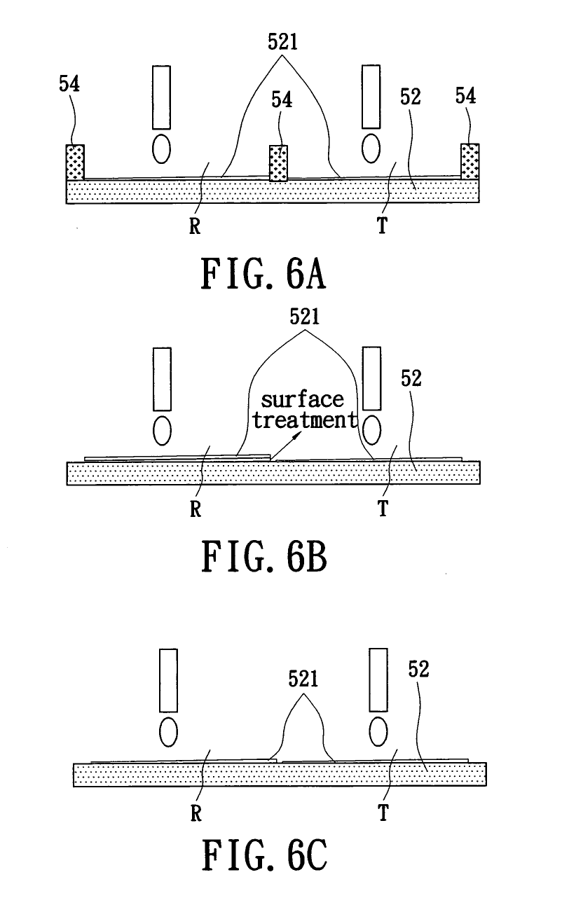

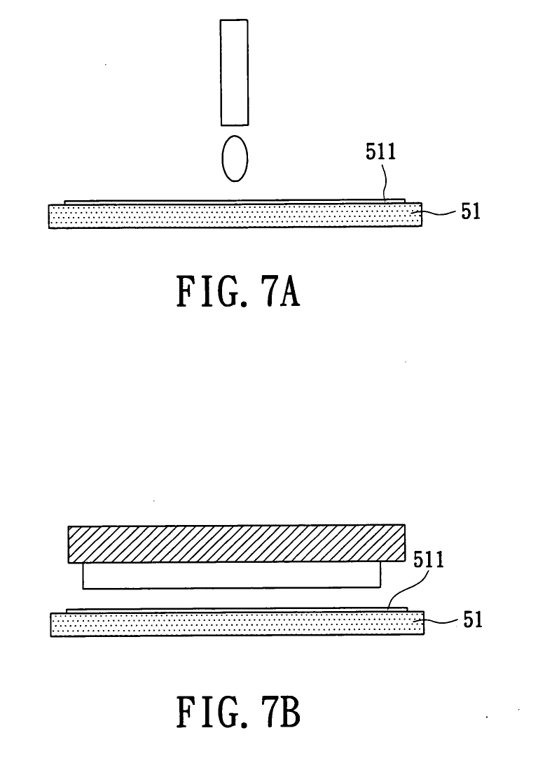

Reference is made to FIGS. 6A-6C. The lower alignment film 521 disposed on the bottom substrate 52 is made of two different alignment materials. The reflective region R and the transmissive region T are formed in the corresponding regions thereby. The lower alignment film 521 can be provided on the bottom substrate 52 via an ink-jet printing process. The patterned alignment layers could be fabricated by filling alignment materials to a patterned substrate defined by multiple separating walls or by surface treatment on the substrates. Due to different surface tension, the two different alignment materials do not mix together. The top substrate 51 has an upper alignment film 511 as shown in FIG. 7A and FIG. 7B.

In practice, except for using the ink-jet printing process, the flexography and the molding processes can also be used to dispose the alignment film.

The transflective display device 50 further includes a top electrode layer, a bottom electrode layer and a color filter (not shown). The top electrode layer can be disposed between the top substrate 51 and the upper alignment film 511 while the bottom electrode layer can be disposed between the bottom substrate 52 and the lower alignment film 521. The color filter can be disposed on the top substrate 51 or the bottom substrate 52 to make the color transflective display device 50.

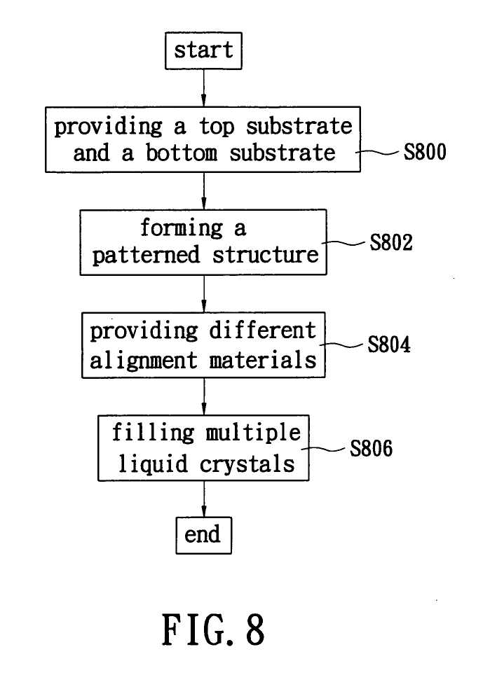

Reference is made to FIG. 8 together with FIGS. 5A-5B. The transflective display device 50 is made via following manufacturing steps. First, the top substrate 51 and the bottom substrate 52 are provided (step S800). Then, the top substrate 51 or the bottom substrate 52 is processed to form a patterned structure (step S802). In step S802, a photo lithography process, a printing process, a coating process, a molding process or a photo-induced polymerization process can be used to form the patterned structure composed of multiple separating walls 54. Moreover, the patterned structure can also be formed by changing the surface tension (surface treatment) of the top substrate 51 or the bottom substrate 52. In the practical manufacturing procedure, step S802 could be omitted.

In step S804, different alignment materials are provided on the patterned structure of the top substrate 51 or the bottom substrate 52. The upper alignment film 511 and the lower alignment film 521 are provided by using an ink-jet printing process, the flexography or the molding process Lastly, liquid crystals are filled between the top substrate 51 and the bottom substrate 52 to form the liquid crystal layer 53 (step S806).

The manufacturing process of the LCD device 50 can further include following steps. A reflective plate is provided on the bottom substrate 52 to form a reflective region R. The region of the bottom substrate 52 not covered by the reflective plate forms a transmissive region T. A top electrode layer is provided on the top substrate 51 while a bottom electrode layer is provided on the bottom substrate 52. A color filter is provided on the top substrate 51 or the bottom substrate 52.

In the present invention, multiple liquid crystal domains are formed by using different alignment materials on the top and bottom substrate. Large-sized display devices with multiple liquid crystal domains can be made easily by using such technique. The different alignment materials can be provided on the corresponding regions via a simple process such as ink-jet printing. Compared with the photo alignment technique, the ink-jet printing is cheaper and much simpler. Hence, the cost is reduced and the manufacturing procedure is simplified.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A liquid crystal display (LCD) device, comprising:
a top substrate;
an upper alignment film disposed below the top substrate;
a bottom substrate;
a lower alignment film disposed above the bottom substrate; and
a liquid crystal layer disposed between the top substrate and the bottom substrate;
wherein the alignment films are patterned and formed by providing different alignment materials on the corresponding regions of the substrates.

2. The LCD device as claimed in claim 1, wherein the upper alignment film or the lower alignment film is formed by using at least two different alignment materials.

3. The LCD device as claimed in claim 2, wherein multiple liquid crystal domains having different alignment orientations are formed when the different alignment materials contact liquid crystal molecules of the liquid crystal layer.

4. The LCD device as claimed in claim 1, wherein the bottom substrate has multiple reflectors disposed thereon to form multiple reflective regions, and other regions of the bottom substrate not covered by the reflectors form multiple transmissive regions.

5. The LCD device as claimed in claim 4, wherein the multiple reflective regions and the multiple transmissive regions of the lower alignment film have different alignment materials.

6. The LCD device as claimed in claim 5, wherein different alignment orientations are formed when the different alignment materials contact liquid crystal molecules of the liquid crystal layer.

7. The LCD device as claimed in claim 1, wherein liquid crystal molecules of the liquid crystal layer are cholesteric liquid crystals, nematic liquid crystals, or smectic liquid crystals.

8. The LCD device as claimed in claim 1, wherein the substrates have multiple separating walls.

9. The LCD device as claimed in claim 1, wherein the substrates have a patterned structure formed by surface treatment.

10. A method for manufacturing a LCD device, comprising:
providing a top substrate and a bottom substrate;
forming a patterned structure on at least one of the substrates;
providing different alignment materials on the patterned structure; and
filling multiple liquid crystal molecules between the top and bottom substrates to form a liquid crystal layer.

11. The method as claimed in claim 10, wherein the step of forming the patterned structure comprises disposing multiple separating walls on the substrate.

12. The method as claimed in claim 11, wherein the separating walls are formed by using a process such as photo lithography, printing, coating, molding and photo-induced polymerization.

13. The method as claimed in claim 10, wherein the patterned structure is formed by surface treatment of the substrates.

14. The method as claimed in claim 10, wherein the step of providing the different alignment materials is performed via a coating process.

15. The method as claimed in claim 14, wherein the coating process is a process such as ink-jet printing, flexography and molding.

16. The method as claimed in claim 10, further comprising:
providing multiple reflectors on the bottom substrate to form reflective regions, wherein regions of the bottom substrate not covered by the reflectors form transmissive regions.

17. A method for manufacturing a LCD device, comprising:
providing a top substrate and a bottom substrate;
providing different alignment materials on at least one of the substrates; and
filling multiple liquid crystal molecules between the top and bottom substrates to form a liquid crystal layer.

18. The method as claimed in claim 17, wherein the step of providing the different alignment materials is performed via a coating process.

19. The method as claimed in claim 18, wherein the coating process is a process such as ink-jet printing, flexography and molding.

20. The method as claimed in claim 17, further comprising:
providing multiple reflectors on the bottom substrate to form reflective regions, wherein regions of the bottom substrate not covered by the reflectors form transmissive regions.
